(19) United States
(12) Patent Application Publication
(10) Pub. No.: US 2005/0069398 A1
(43) Pub. Date: Mar. 31, 2005

(54) Fastener

(76) Inventor: Wesley Arbuckle, Glasgow (GB)

Correspondence Address: Gregory J Lavorgna;Drinker Biddle & Reath, One Logan Square, 18th & Cherry Streets, Philadephia, PA, 19103-6996, US

(21) Appl. No.: 10/492,340

(22) PCT Filed: Oct. 11, 2002
(86) PCT No.: PCT/GB02/04610

(30) Foreign Application Priority Data
Oct. 11, 2001 (GB) 0124425.0
Nov. 9, 2001 (GB) 0126962.0

(51) Int. Cl. F16B 13/04

(52) U.S. Cl. 411/477; 411/34

(57) ABSTRACT

A fastener has legs biased apart by biasing means. In use, a cable or the like is received within the biasing means, and the legs are squeezed together and inserted in a hole in a wall or ceiling. The biasing force of the biasing means retains the fastener within the hole; optionally, the legs may be provided with spikes angled to resist removal.

The present invention relates to a fastener used particularly, but not exclusively, for fixing cables, pipes and conduits of differing dimensions to surfaces such as walls and ceilings formed of, for example, brick, concrete, stone, plasterboard, timber, plastics and metals. The fastener may also be used as an alternative to nails, screws or hooks (and the like), as a fixing on a surface, and to fix a number of cables (and the like) to surfaces.

Conventionally, cables and the like are held to a wall or ceiling by fitting an attachment around the cable and screwing or nailing the attachment to the wall or ceiling. This is time consuming and requires a number of components and tools.

According to the present invention there is provided a fastener for attachment to a surface such as a wall or ceiling, the fastener including two legs, and a biasing means, the legs being biased apart by the biasing means in a pre-installation condition and the legs capable of being brought together to allow the fastener to be installed into a hole in the surface, wherein, when installed, the biasing means urges the legs against the interior of the hole, such that the fastener is held in the hole.

In particularly preferred forms of the invention, the legs and the biasing means are integrally formed, for example from spring steel strip, and the legs are provided with one or more spikes angled to resist removal of the fastener from the hole.

The present invention also provides a method of attaching an article to a wall or ceiling, the method comprising:
providing a fastener as defined above;
drilling a hole in the wall or ceiling;
positioning the fastener over the article; and
inserting the fastener into the hole.

Typically, the article is a cable, pipe or the like. The hole may be made in a solid wall including brick, concrete, stone or timber, or a panel such as plasterboard, plastics and metals.

Other preferred features and advantages of the invention will be apparent from the following description and claims.

Embodiments of the fastener of the present invention will now be described, by way of example only, with reference to the accompanying drawings, in which:

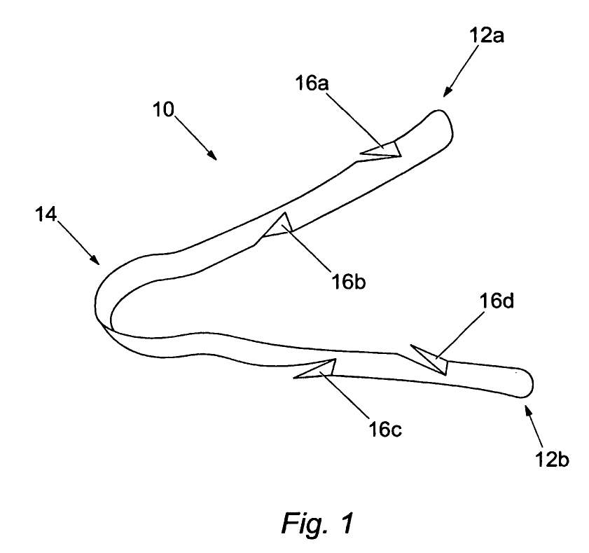

FIG. 1 is a schematic perspective view of a first embodiment of the fastener of the present invention;

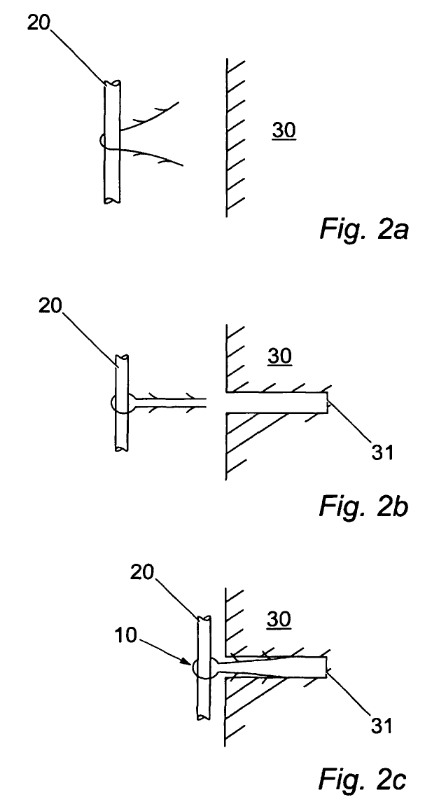

FIGS. 2a to 2c are schematic part cross-sectional elevational views of the steps in connecting a cable to a wall using the fastener of FIG. 1;

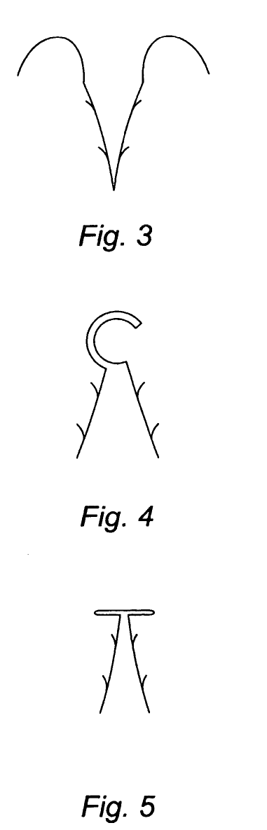

FIGS. 3 to 5 are schematic side views of alternative embodiments of the present invention;

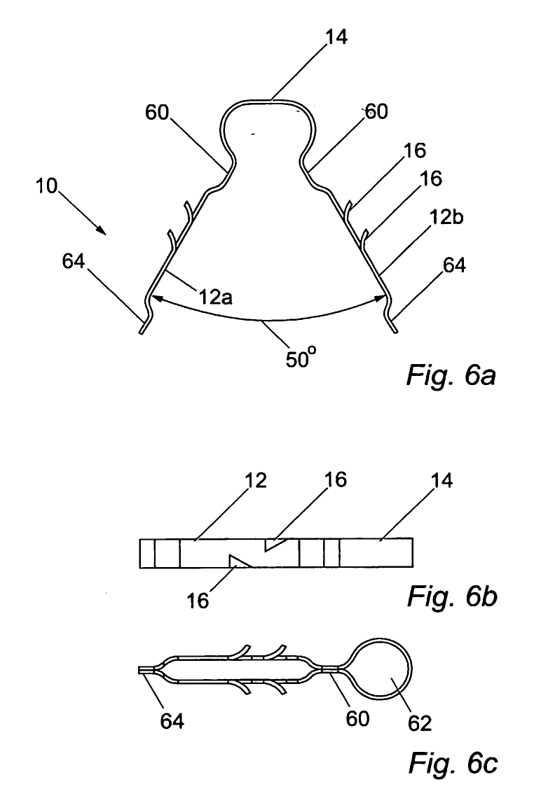

FIG. 6A is a side view of a modified version of the embodiment of FIG. 1 in a free state; and

FIGS. 6B and 6C are a plan and side view, respectively, of the fastener of FIG. 6A in a compressed state.

Referring to the drawings, a fastener 10 is formed of one piece of 0.3 mm spring steel with a tempered finish. The fastener 10 has two legs 12a and 12b and a biasing means 14.

The biasing means 14 is interposed between the two legs 12a and 12b and biases the two legs 12a and 12b apart (FIG. 1 illustrates the two legs 12a and 12b in the fully biased apart, pre-installation, condition).

Each of the two legs 12a and 12b has a respective pair of securing spikes 16a, 16b and 16c, 16d in the form of triangular barbs which are formed from the material of the legs 12a and 12b. The barbs 16a-d are directed generally towards the biasing means 14.

The biasing means 14 is formed integrally with the two legs 12a and 12b and the biasing force is supplied by a pre-tensioning in the material which forms the fastener 10, such that when the two legs 12a and 12b are brought together by a user, the bias force urges the two legs 12a and 12b apart.

The fastener 10 is also adapted to fit around a cable 20 and in use (FIGS. 2a-c), the cable 20 is fitted to a wall, ceiling or the like by placing the fastener 10 around the cable 20 (FIG. 2a), drilling a hole 31 in the wall 30 and a user squeezing the two legs 12a and 12b together (FIG. 2b). The two legs 12a and 12b of the fastener 10 are then inserted into the hole 31 and released.

As seen in FIG. 2c, the bias force then urges the two legs 12a and 12b apart and the legs 12a and 12b engage the interior of the hole 31. The barbs 16a-d also engage the interior surface in an anchor-like manner, and because of the orientation of the barbs 16a-d (i.e. the barbs 16a-d facing towards the biasing means 14) any force to try to remove the fastener 10 from the hole, merely causes the barbs 16a-d to anchor further into the hole, thus securing the fastener 10 even more securely.

The fastener 10, formed of steel, has particular application in securing cable 20 specifically used in fire safety system applications but can also be used for normal domestic and industrial applications. The fastener 10 can be used in corrosive, hazardous, indoor and outdoor environments. No tools are required to fit the fastener 10 (once a hole has been drilled), and the installation is fast, easy, reliable and secure.

The fastener 10 can be made by a progression pressing tool with a multi-change application to enable different sizes of fastener to be produced to accommodate different diameters of cable, or a number of cables.

The fastener 10 is plated with bright zinc, however, different types of finish can be used, for example coloured finishes.

In a specific form, the design and orientation of the barbs 16a-d is such that a force of 9 to 13 kg is required to pull the fastener 10 from the hole 31.

Referring to FIGS. 3 to 5, there are illustrated alternative embodiments of the fastener 10 which operate in a similar way to the first embodiment described above (and which is illustrated in FIGS. 1 and 2).

Referring to FIG. 3, there is shown a second embodiment of the present invention. The fastener 110 includes a single element bent to form two legs 112a and 112b and having cable receiving means 150a and 150b respectively attached to the free ends of each of the legs 112a and 112b. The element is bent at location 140 and the bending of the element provides the biasing means 114, which biases the legs 112a and 112b apart. The legs 112a and 112b also include barbs which operate in a similar way as described in the first embodiment. In alternative embodiments, only one cable receiving means (150a, for example) may be provided and the legs 112a and 112b may be formed from two or more separate elements joined together in such a manner that their respective free ends are biased apart.

Referring to FIG. 4, there is shown a third embodiment of the present invention. The fastener 210 includes a single element bent to form two legs 212a and 212b and to form a hook 250 positioned between the two legs 212a and 212b. The bending of the element provides the biasing means which biases the legs 212a and 212b apart. The legs 212a and 212b also include barbs which operate in a similar way as described in the first embodiment. In an alternative embodiment, the legs 212a and 212b and the hook 250 may be formed from two or more separate elements joined together in such a manner that their respective free ends are biased apart.

Referring to FIG. 5, there is shown a fourth embodiment of the present invention. The fastener 310 includes a single element bent to form two legs 312a and 312b and a flattened head 350 positioned between the two legs 312a and 312b. The bending of the element provides the biasing means which biases the legs 312a and 312b apart. The legs 312a and 312b also include barbs which operate in a similar way as described in the first embodiment. In an alternative embodiment, the legs 312a and 312b and the flattened head 350 may be formed from two or more separate elements joined together in such a manner that their respective free ends are biased apart. The flattened head 350 is suitable for securing panels or other planar articles to a wall or ceiling.

FIG. 6 shows a modified version of the embodiment of FIG. 1. It will be noted that the legs 12 are formed with cooperating inward portions 60 which, in the compressed state, help to define a circular passage 62 for a cable. The legs 12 are also formed with cooperating inward portions 64 at their distal ends. The portions 60, 64 serve to define a minimum spacing between the legs 12 in the compressed state, which can be chosen to match a desired hole diameter, and also to provide additional resilience to the action of the spikes 16.

Modifications and improvements may be made to the foregoing without departing from the present invention. For example, the biasing means and the two legs may not be integrally formed but may be connected in various other ways; whilst the biasing force results from the nature of the material used (i.e. spring steel), the biasing force may comprise a separate spring or the like; and it will be appreciated by a person skilled in the art that the barbs are optional features and the fastener will secure into the hole, with or without the barbs. Materials other than steel may be used, for example the fastener may be an integral plastic moulding, or a moulded plastics element provided with a metallic spring and metal spikes.

1. A fastener for use in securing articles to walls or ceilings, the fastener including an element having two ends, and a biasing means, the ends being biased apart by the biasing means in a pre-installation condition and the ends capable of being brought together to allow the fastener to be installed into a hole in a wall or ceiling, wherein, when installed, the biasing force supplied by the biasing means urges the ends against the interior of the hole, such that the fastener is held in position.

2. A fastener according to claim 1, in which the element and the biasing means are integral and the element is formed of a single piece of material.

3. A fastener according to claim 2, in which said single piece of material is shaped and dimensioned to accommodate a cable by fitting around at least part of the circumference of the cable.

4. A fastener according to claim 2, in which said single piece of material is shaped to form a head suitable for engaging a panel.

5. A fastener according to claim 3, for use with cables in fire systems.

6. A fastener according to claim 1, in which the biasing means is a spring.

7. A fastener according to claim 2, in which the bias force supplied by the biasing means results from the physical properties of the element itself.

8. A fastener according to claim 1, further including at least one securing spike positioned to anchor into the hole to further secure the fastener in the hole.

9. A fastener according to claim 8, in which the spike is integrally formed from the element.

10. A fastener according to claim 8, in which there are a number of spikes and the spikes are angled such that a force applied to try to remove the element from the hole results in the spikes digging further into the interior of the hole.

11. A fastener according to claim 1, which is formed of steel.

12. A fastener according to claim 11, formed of spring steel.

13. A fastener according to claim 11, formed of 0.3 mm spring steel.

14. A fastener according to claim 11, in which the steel has a tempered finish.

15. A fastener according to claim 11, in which the fastener is zinc plated.

16. A fastener according to claim 11, in which a coloured finish is applied to the fastener.

17. A fastener according to claim 1, the fastener being adapted to accommodate different diameters of cable and capable of accommodating a number of cables.

18. A method of attaching an article to a wall or ceiling, the method comprising:
providing a fastener in accordance with any preceding claim;
drilling a hole in the wall or ceiling;
positioning the fastener over the article; and
inserting the fastener into the hole.

19. A method according to claim 18, in which the article is a cable, pipe or the like.

20. A method according to claim 18, in which the hole is made in a solid wall including brick, concrete, stone or timber, or a panel such as plasterboard, plastics and metals.
